(19) United States
(12) Patent Application Publication
(10) Pub. No.: US 2016/0089297 A1
(43) Pub. Date: Mar. 31, 2016

(54) APPARATUS FOR TREATING THE HUMAN OR ANIMAL BODY WITH MECHANICAL STROKES

(71) Applicant: STORZ MEDICAL AG, Tägerwilen (CH)

(72) Inventors: Stephan Gerhard Swart, Moers (DE); Carlo Di Maio, Duisburg (DE); Ulrich Piontkowski, Bietigheim-Bissingen (DE); Pavel Novak, Stetten (CH); Johannes Manfred Schulz, Tägerwilen (CH)

(21) Appl. No.: 14/865,847

(22) Filed: Sep. 25, 2015

(30) Foreign Application Priority Data
Sep. 26, 2014 (EP) 14 186 613.7

(51) Int. Cl. A61H 9/00

(52) U.S. Cl. CPC A61H 9/005; A61H 2201/50; A61H 2205/08; A61H 2205/062; A61H 2201/0157

(57) ABSTRACT

The invention relates to an apparatus for treating the human or animal body by strokes and an applicator 11 provided for that purpose, having a curved-flat shape with a concave and a convex lateral face.

### CROSS-REFERENCE TO RELATED APPLICATION'S

Not Applicable.

### FEDERALLY SPONSORED RESEARCH OR DEVELOPMENT

Not Applicable,

### MICROFICHE/COPYRIGHT REFERENCE

Not Applicable.

### FIELD OF THE INVENTION

The present invention relates to an apparatus for treating the human or animal body by applying strokes to the body surface. Below, for a simplification, reference is made to the body of a patient which is preferably human.

### BACKGROUND OF THE INVENTION

In the prior art, different apparatuses of the basic type described are known. DE 197 25 477 C relates to such an apparatus for instance, wherein a shockwave is initiated by a collision of a pneumatically accelerated striking member or projectile with an impact body or applicator resting initially, wherein the shockwave can be coupled into the body of the patient when a front area of the applicator is placed on the patient's body at the time of the collision. As regards the history of its development, this type of apparatus results from lithotripsy apparatuses which can be used for transferring such a shockwave onto a kidney stone or the like for a disintegration, for instance via a long rod-like probe at the front area of the applicator.

Therein, an emphasis is on the shockwave generated by the collision, which can be more or less comparable to an actual shockwave generated by a classical lithotripsy apparatus having for instance a piezoelectric or inductive actuator and a focusing on a stone, Such shockwaves can have a leading edge with a width in the region of a few ps and an amplitude in a lower double-digit MPa region (for instance 2 μs and 15 MPa measured 1 cm in front of the front area). In the document cited however, it is emphasized that the macroscopic movement of the applicator's center, which cannot be prevented as such physically, shall be kept rather small because it is considered as disadvantageous.

As a second example, reference is made to DE 20 2004 011 323 U and US 2011/0054367 A1 having a comparable content. There, an apparatus which is comparable as regards its technical design is described, the elastic mounting of the applicator in the housing being however adapted for a larger movement of the applicator's center (“travel”). There, it is emphasized that a therapeutic effect can be caused also or mainly by the actual macroscopic strokes (namely as a result of the travel), which also depends from the indication.

In general, the present invention relates to apparatuses of that type, namely regarding the application of shockwaves as well as regarding the application of “macroscopic strokes” of the applicator to the body surface.

Therein, the invention is to solve the problem to provide such an apparatus with further application possibilities.

### SUMMARY OF THE INVENTION

The problem is solved by an apparatus according to claim 1. Therein, according to the invention, the applicator is curved-flat and has a concave lateral face and a convex lateral face opposite thereto in conformity with this curvature. The lateral faces have a corresponding shape insofar as the applicator has a limited size in between, namely is “flat” which refers to the limit value of ⅓ at maximum of the extension of the applicator along the concave and the convex lateral face.

This comparison refers to the length (in a straight manner, not following the curvature in a curved manner) of the applicator from the beginning up to the end of the described curved shape. When it amounts for instance to approximately 30 mm, as in the exemplary embodiment, the size between the convex and the concave lateral face shall be 10 mm at maximum, preferably ¼ at maximum or even ⅕ at maximum, namely 7.5 mm at maximum or 6 mm at maximum in this example. Basically, this shall not exclude an applicator having thicker regions, for instance in a mounting section for connecting to the remaining apparatus. They are however not considered as belonging to the shape according to the invention and preferably only occur proximal to the latter and not distal thereto (the terms proximal and distal refer to the stroke direction).

It turned out that the flat curved shape can ease the handling of the apparatus by the therapist. In particular, the curved shape allows “reaching” behind certain body structures without the therapist having to hold a conventional apparatus in an unpractical manner tilted or having to press it onto the body surface with a particularly high pressure for compressing the skin of the patient sufficiently extensively. An example is the lower end of the ribs. With the applicator according to the invention, the therapist can reach somehow around the lower rib wherein the concave lateral face puts against the rib and therein maintains an ergonomical and practical working position. Therein, due to the limited size of the applicator, only a limited portion of the skin has to be pushed in and away.

Comparably, the invention has advantages when treating the muscles within the shoulder blade; again, the therapist can reach around the shoulder blade with the applicator.

Further, the convex side can be used as an oblique area for a movement over the body surface when the apparatus is held obliquely with respect to the body surface. Then, the apparatus can be held better and can be moved over the body surface in a manner better controllable and more comfortable for the therapist. Therein, in particular, tissue portions below the skin can be massaged and/or pushed along in front of the apparatus while being treated at the same time with the strokes and (to a different extent as the case arises) shockwaves. Therein, the apparatuses conventionally known having an applicator with a more or less flat front area are rather inadequate, because they can only be placed on the skin surface in a more or less perpendicular orientation of the apparatus with respect to the body surface.

The apparatus for generating the strokes of the applicator can be provided in various designs, in particular also by a direct admission of the applicator by an electromagnetic mechanism or a pressure pulse. However, preferably, an accelerated projectile as known from the cited documents is used for a collision with the applicator, which results in rather intense and in terms of the velocity of the applicator) fast strokes and allows a use of shockwaves at the same time or even primarily. Again, the projectile can be also accelerated in different ways, in particular also electromagnetically, wherein a pneumatic admission of the projectile as described in the documents cited is also preferred here.

The term “applicator” does not necessarily relate to a one-piece part. It is also possible and also preferred depending on the application that the projectile hits a first part for instance, which transmits the stroke and/or the shockwave onto a second applicator part contacting the skin of the patient. Occasionally, an intermediate piece between the applicator and the projectile is referred to in the prior art; insofar, a multi-part applicator is referred to, wherein the two applicator parts can be firmly attached, which is not necessary however.

As mentioned above, a comparably large travel of the applicator can be required, wherein in the present case the apparatus is preferably provided such that strokes with a travel above 1 mm can be reached, as already described in US 2011/0054367 A1.

Preferably, the applicator according to the invention has exactly the gradient of curvature described, namely no further gradient with a different orientation of the curvature, for instance opposite or in a significantly different plane of the curvature. Such a simple shape of the applicator is not only advantageous in view of the manufacturing but also practical and uncomplicated in use.

Further, the convex and the concave lateral face are preferably arranged such that a sectional plane in which the respective curvature is particularly pronounced, contains the stroke direction, wherein the centers of curvature occurring lie aside the applicator laterally with respect to the stroke direction. In other words, the applicator shape is curved such that the convex lateral face points to one side with respect to the stroke direction (and not to the front or behind with respect to the stroke direction) and the concave lateral face points to the opposite side. Assuming for simplification that the applicator shape has the shape of a banana in a sectional plane (see the exemplary embodiment), which is an example for illustration, one end of this banana is located proximal to the apparatus and the other one distal, the banana being for instance not arranged with its center proximal to the apparatus both ends pointing away therefrom.

Further, the curvature is preferably more pronounced in the proximal than in the distal region of the applicator, the respective radii of curvature increasing with an increasing distance to the apparatus, which is also illustrated by the exemplary embodiment.

A further preferred embodiment relates to a dimension not discussed so far, namely the width perpendicularly to the stroke direction and to the plane in which the curvature occurs. Insofar, the applicator is at least as wide as the size mentioned above (the size referred to by the term “flat”), preferably it is at least 1½ times as wide or even at least 2 times, 2½ times or even 3 times as wide. So, “flat-wide” geometries are preferred and for instance rod-like geometries are not (therefore, the aforementioned comparison to a banana relates to a section).

Finally, the applicator is preferably “edge free” in terms of radii of curvature of 1.5 mm at minimum in at least one sectional plane in which preferably the described curvature is observed and particularly preferred also in a second sectional plane perpendicularly thereto, see the exemplary embodiment, the applicator being edge free mainly in a front region, in particular in the distal half (with respect to the longitudinal extension in the stroke direction).

As a whole, preferred dimensions result for a part of the applicator, which is free from the remaining apparatus (particularly projects therefrom):

The length is preferably larger than 10 mm, 20 mm, 30 mm or even 35 mm and preferably smaller than 100 mm, 90 mm, 80 mm, 70 mm, 65 mm or even 60 mm. In the exemplary embodiment, it is about 50 mm. Therein, the length of the actual flat-curved section is about 32 mm (in the stroke direction) in case of the exemplary embodiment and, in general, is preferably more than 5 mm, 10 mm, 15 mm or even 20 mm and preferably less than 60 mm, 50 mm or even 40 mm.

The width is preferably above 5 mm, 10 mm or even 15 mm and, on the other hand, preferably below 80 mm, 60 mm, 40 mm or even 30 mm, it is 20 mm in case of the exemplary embodiment.

The size is preferably at least 2 mm, 3 mm or even 3.5 mm and preferably less than 10 mm, 9 mm, 8 mm or even 7 mm, it is 5 mm in case of the exemplary embodiment.

Further, the front part (distal part) should have an angle with respect to the moving direction of at least 20° or even 25° and not more than 80°, 70° or even 60°. In case of the exemplary embodiment, it is about 40° in the final section.

Preferably, this angle is achieved by a curvature which preferably flattens from the proximal section to the distal section (the radius of curvature increases thus), in the distal region, a preferred radius of curvature can be typically above 15 mm, 20 mm or even 25 mm and below 80 mm, 75 mm, 70 mm, 65 mm, 60 mm or even 55 mm; in the exemplary embodiment, the radius of curvature is 40 mm there. On the other hand, it is only 5 mm in the proximal section in case of the exemplary embodiment and increases from there on.

Further, the distal end of the applicator is preferably arranged more or less centrically with respect to the stroke direction, namely preferably within 15 mm or even only 5 mm around a center longitudinal axis of the apparatus.

The applicators known consist usually of stainless steel, in the present case, metals can be used in general, in particular stainless steel. Further metallic materials can for instance be aluminium or titanium, both having a comparably low mass density which enables rather lightweight applicators. This can be advantageous since a stronger acceleration and larger travel thus are possible at a given geometry of the applicator, which can be desired in the present case. Further, titanium is characterized by a high mechanical loadability, being appropriate for applications with a comparably high velocity of the projectile and/or mass of the projectile but not only therefore. Often, the low density and/or a good physiological tolerance is decisive. Further, ceramics, see the application no. 08 003 840.9/EP 2 095 843, and synthetic materials can be used. In comparison to stainless steel, those are also advantageous in view of having a smaller mass density. Further, the heat conductivity is smaller than in case of metals so that the patient perceives the applicator as being warmer subjectively. This applies in particular for synthetic materials. Synthetic materials are in particular of interest when the coupling of the shockwave is less important, because there can be certain losses in the wave conductance in comparison to the aforementioned materials, at least when a larger thickness of the synthetic material is assumed.

### BRIEF DESCRIPTION OF THE DRAWINGS

Below, the invention is explained in further details by means of an exemplary embodiment wherein the individual features can, in the scope of claim 1, be also relevant for the application independently of each other and in other combinations.

FIG. 1 shows a shockwave apparatus as a first exemplary embodiment of the invention, having an applicator shown in FIG. 2 in further detail.

FIG. 2 shows a front part of the applicator of the apparatus of FIG. 1 in the same viewing direction as in FIG. 1 (but upright) and in a longitudinal section in the representation part a, in a top view with a viewing direction turned around the longitudinal axis by 90° in the representation part b, looking in the length direction of the apparatus in a further representation c and finally in a perspective view in the representation part d.

### DETAILED DESCRIPTION OF THE INVENTION

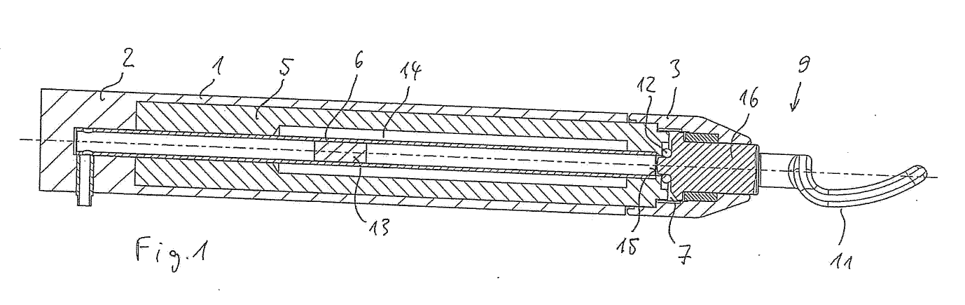

FIG. 1 shows a first embodiment of the invention. It is an apparatus for coupling strokes and unfocused (so-called radial) mechanical shockwaves into the human or animal body.

A tube piece 1 forms a housing, namely together with an air inlet cap 2 pointing away from the body in the application and being integrated with the tube piece 1 and an applicator cap 3 pointing towards the body in the application. The air inlet cap 2 comprises a compressed air supply 4 for a pneumatic supply. In a manner known as such, a valve controlled by a control unit, in particular a magnetic valve, is connected to this compressed air supply 4 via a pneumatic supply line, the valve coupling compressed air pulses in a constant repetitive cycle between for instance 1 Hz and 50 Hz via the compressed air supply. The valve is not shown and can also be integrated into the shown apparatus itself.

Further, the apparatus is an apparatus to be held by hand by an operating personnel, being connected via the aforementioned pneumatic line to a base station with the control unit and the compressor and being placeable on the patient manually. It can be used for treating body parts behind body imminent structures like ribs or shoulder blades.

In the housing, a guiding tube 6 is held by an inset 5, whose end being distal to the body in the application is terminated by the air inlet cap 2 and communicates with the compressed air supply 4 there. The end of the guiding tube 6 which is proximal to the body in the application ends in a part of the inset 5, the part projecting into the applicator cap 3, namely ends briefly before the local end of the inset 5 and before an inner space 7 in the applicator cap 3.

In the inner space 7 which merges into an applicator opening proximal to the body in the application, a first part of an applicator 9 is received which is hatched in FIG. 1. Via an elastic tube element 10 made of an elastomer, it rests on a radial collar. An end 15 of the applicator 9, oriented to the side distal to the body and containing the impact area, rests on the inset 5 via an O-ring 12, namely at a front face surrounding the end of the inset 5 mentioned above. Therein, the O-ring 12 is located between this front face and a collar of the applicator 9. Therein, the applicator opening 8 provides a guidance of the applicator 9 with a movability in the length direction and secures it obliquely to the length direction. The axial displaceability is only limited by the deformability of the elastomer element 10 and can be significantly above 1 mm with respect to the remaining apparatus in case of an apparatus driven by air.

As a further part, the applicator 9 comprises the element 11 being not hatched, which forms the actual applicator applied to the skin. The applicator 9 can be exchanged by unscrewing the applicator cap 3.

In the adjacent region of the guiding tube 6, a projectile 13 is inserted, which is in contact with the applicator 9 in FIG. 1. It fits therein with a minor clearance (with respect to the guiding tube and the basically cylindrical geometry of the projectile 13). The projectile 13 can be moved to-and-fro in the guiding tube 6 by pressure gradients in the air column in the guiding tube 6 in front of and behind the projectile (namely at the right and the left of the projectile 13 in FIG. 1), in particular it is accelerated onto the applicator 9. Therefore, it is accelerated from an initial position (not shown) on the left in FIG. 1 by a pressure pulse through the compressed air supply 4 and hits the applicator 9 with a front area pointing towards the applicator 9, namely hits a impact area 15 thereof pointing away from the body.

In addition to a rebound after the collision, the backward motion of the projectile 13 is supported by air flowing back from an accumulation chamber 14 surrounding the guiding tube 6 within the inset 5. Into the accumulation chamber, the air is displaced during the acceleration of the projectile 13 towards the impact body 9 and it is compressed therein. When the pressure is released by the magnetic valve, the space behind the projectile being vented therein, the projectile 13 is moved back into the initial position. In addition or alternatively, this can also occur by a pressurization of the accumulation chamber 14 or of another air volume at a side of the projectile 13 proximal to the body. The end of the guiding tube 6 being distal to the body in the application, ends at a magnet holder for the projectile 13.

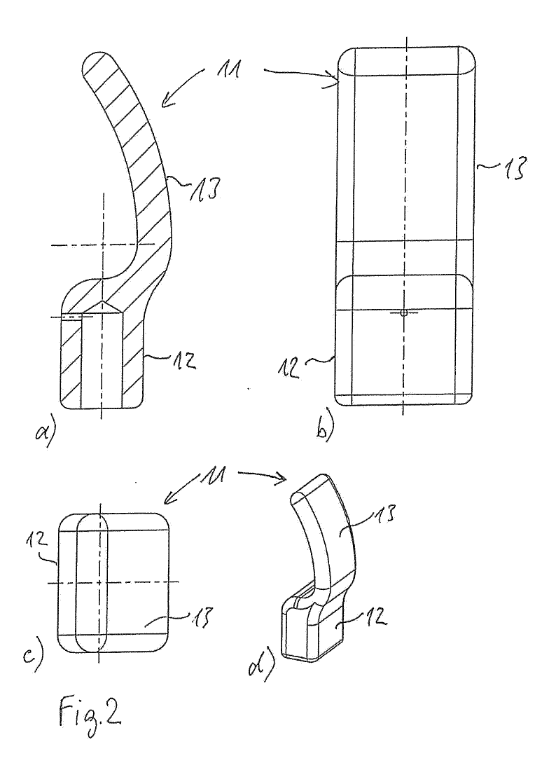

If the hatched part 16 of the applicator 9 in FIG. 2 would be terminated by for instance a slightly convex boundary line, this would be the conventional shape of an applicator. With such a shape, the applicator 9 would be primarily adapted for being placed vertically on the body surface of the patient. According to the invention, the applicator 9 is complimented towards the patient's body, namely by the part 11 without hatching. Seen in a direction perpendicular to the longitudinal direction, the latter has the shape shown in FIG. 1 and it has the shape shown in FIG. 2b in the second direction perpendicular to the first direction and the longitudinal direction. Therein, the applicator 9 is shown approximately in an appropriate ratio to the remaining apparatus in FIG. 1 but is enlarged in FIG. 2.

In FIG. 2a, a longitudinal section through the front part 11 of the applicator is visible. Therein, at the (proximal) side pointing to the apparatus a hollow receiving space is drawn, which can be used for the connection to the remaining applicator but is not further of relevance here. Anyhow, a flat-curved shape 13 initially displaced laterally with respect to the socket follows on the socket 12 which is rectangular (with rounded corners) in a section perpendicular to the stroke direction.

The flat curved shape 13 starts from the socket with an inner radius of curvature of 5 mm, which increases gradually to the tip of the flat-curved shape 13 up to 40 mm, wherein the tip itself is rounded with a radius of 2.5 mm, With respect to the stroke direction, the tip is tilted by 40°. At the outside of the flat-curved shape 13, the radius of curvature amounts to 45 mm approximately, the material size visible in the section in FIG. 2a amounting to 5 mm. However, the width visible in FIG. 2b amounts to 20 mm over the whole region of the flat-curved shape 13, wherein only the corners are rounded. Looking vertically onto the upper part of the applicator 11 of FIG. 2b, namely turned by 40° in comparison to the viewing direction of FIG. 2b, the radius of the rounding in the two upper corners is 5 mm. FIG. 2c shows a top view, namely a view in the stroke direction, and FIG. 2d a perspective view, wherein the concave side points backwards to the left and the convex side frontwards to the right. It can be seen that the tip is in a region of around 5 mm around the longitudinal axis (in stroke direction) to both sides.

FIGS. 1, 2a and 2d show that the front part 11 of the applicator has exactly one gradient of curvature with a concave lateral face (in FIG. 2a to the left) and a convex one (to the right), wherein FIG. 2a shows further that the centers of curvature of the concavity and the convexity lie laterally aside the applicator 9 or 11 in the sectional plane there, namely at the left thereof. Further, it can be seen that the curvature decreases from a proximal to a distal region.

With such a front part 11 of the applicator, the person treating can reach around certain body structures as for instance ribs and shoulder blades, being particularly suited for certain applications thus.

1. An apparatus for treating a human or animal body, having
an applicator (9,11,16) for being placed on said body from the outside,
a housing (1,2,3) in which said applicator (9,11,16) is held, and
an apparatus (4,6,13) for generating strokes of said applicator (9,11,16) with respect to said housing (1,2,3) in a stroke direction so that said strokes can be coupled into said body when said applicator is placed on said body,
characterized in that said applicator (9,11,16) has a curved-flat shape with
a concave lateral face to one side,
a convex lateral face to a side opposite thereto
and a size between said lateral faces, which amounts to one third at maximum of an extension of said applicator along said concave and said convex lateral face.

2. The apparatus according to claim 1, wherein said apparatus (6,13) for generating said strokes comprises a projectile (13) and a device (6) for accelerating said projectile (13) in such a way that said projectile (13) hits said applicator (9,11,16) and generates said stroke, thus, preferably a pneumatic device for accelerating said projectile (13).

3. The apparatus according to claim 1, having exactly one gradient of curvature being a result of said concave and said convex lateral face.

4. The apparatus according to claim 1, wherein the convexity and the concavity of said lateral faces show in a sectional plane containing said stroke direction, wherein centers of curvature of said concavity and said convexity are respectively located aside said applicator laterally with respect to said stroke direction.

5. The apparatus according to claim 1, wherein the concavity and the convexity have smaller radii of curvature in a region being proximal with respect to said stroke direction than in a region being distal with respect thereto.

6. The apparatus according to claim 1, wherein a width of said applicator (9,11,16) perpendicularly to said stroke direction and perpendicularly to a sectional plane showing the gradient of curvature which is a result of said concave and said convex lateral face is at least as large as said size of said applicator (9,11,16) between said lateral faces.

7. The apparatus according to claim 1, wherein radii of curvature amount to 1.5 mm at minimum in a distal half of said applicator in at least one sectional plane, preferably in two sectional planes.

8. The apparatus according to claim 1, wherein a region (11) of said applicator (9,11,16), which is free of other parts of said apparatus, has a total length in said stroke direction between 10 mm and 100 mm.

9. The apparatus according to claim 1, wherein a region (11) of said applicator (9,11,16), which is free of other parts of said apparatus, has a size between said concave and said convex lateral face of between 2 mm and 10 mm.

10. The apparatus according to claim 1, wherein a region (11) of said applicator (9,11,16), which is free of other parts of said apparatus, has a total width of between 5 mm and 80 mm perpendicularly to said stroke direction and perpendicularly to a sectional plane showing the gradient of curvature which is a result of said concave and said convex lateral face.

11. The apparatus according to claim 1, wherein a part 11 of said applicator (9,11,16), which is adapted for being placed on said body, is made of metal, in particular aluminium or titanium, synthetic material or ceramics.

12. The apparatus according to claim 1, which is adapted for a travel of said stroke of 1 mm at minimum in said stroke direction relatively to said housing.
